(19) United States
(12) Patent Application Publication
(10) Pub. No.: US 2023/0076369 A1
(43) Pub. Date: Mar. 9, 2023

(54) UNIDIRECTIONAL POWER CONVERTERS WITH POWER FACTOR CORRECTION CIRCUITS CONTROLLED USING ADJUSTABLE DEADTIME

(71) Applicant: EnerSys Delaware Inc., Reading, PA (US)

(72) Inventors: Rui ZHOU, Niskayuna, NY (US); Yincan MAO, Wyomissing, PA (US); Qianqian JIAO, Wyomissing, PA (US); Alap SHAH, Reading, PA (US); Jianwu CAO, Reading, PA (US)

(21) Appl. No.: 17/470,249

(22) Filed: Sep. 9, 2021

(51) Int. Cl. H02M 1/38; H02M 3/335; H02M 1/42; H02M 7/219; H02M 1/00; H02M 7/25

(52) U.S. Cl. CPC H02M 1/385; H02M 3/33569; H02M 1/4225; H02M 7/219; H02M 1/425; H02M 1/0067; H02M 7/25

(57) ABSTRACT

Power converters with power factor correction circuits and controllers thereof that are configured to generate frequency-adjustable first and second pulsed signals having respective and complementary phases separated by an adjustable deadtime. For example, a power converter may be configured to receive an alternating current (AC) input signal and output a direct current (DC) output signal. The power converter may include a transformer and a power factor correction circuit. The power factor correction circuit may include: a first switching transistor and a second switching transistor in series with the first switching transistor; and a controller configured to generate first and second pulsed signals having respective and complementary phases and separated by an adjustable deadtime and apply the generated first and second pulsed signals to the first and second transistors, respectively. A primary side of the transformer may be coupled to a node between the first and second switching transistors.

### CROSS-REFERENCE TO RELATED APPLICATIONS

The present application is related to concurrently filed U.S. patent application Ser. No. ______ entitled “POWER FACTOR CORRECTION CIRCUITS CONTROLLED USING ADJUSTABLE DEADTIME,” and to concurrently filed U.S. patent application Ser. No. ______ entitled “POWER CONVERTER TOPOLOGIES WITH POWER FACTOR CORRECTION CIRCUITS CONTROLLED USING ADJUSTABLE DEADTIME,” the entire contents of which are incorporated by reference herein.

### TECHNICAL FIELD

The present disclosure relates generally to power conversion and, more specifically, to power converters incorporating power factor correction circuits and controlling such power factor correction circuits with adjustable deadtime.

### BACKGROUND

Converters and transformers may convert power from alternating current (AC) to direct current (DC) and/or transform power from AC to AC (e.g., from one frequency to another frequency), though DC to AC inverters and DC to DC converters are also of interest. Herein, devices that change a power signal from a first frequency and/or voltage to a second frequency and/or voltage may be referred to generically as converters. One type of converter may accept an AC input voltage and provide a DC output voltage and is known as an AC-DC converter or a rectifier. Another type of converter is a DC-DC converter, which accepts a DC input voltage and provides a DC output voltage.

Some converters utilize solid-state devices, such as transistors, to convert a power signal. For example, some linear power regulators use a linear region of a transistor in conjunction with a feedback loop to output a stable voltage. Although simple and relatively inexpensive, such linear regulation is inefficient. There has thus been significant interest in using switching regulators to transfer charge to a load more efficiently, because a switching element dissipates little power in either of its two states, i.e., fully conducting or switched off.

Many modern power distribution systems utilize a line frequency that is 50 Hz or 60 Hz. Conventional AC to AC converters (transformers) that operate at such frequencies are typically bulky, and there is interest in replacing such bulky transformers with smaller transformers that operate at higher frequencies, which have less volume and weight. For example, high frequency solid state transformers and converters (particularly AC to DC converters) may be enhanced replacements of bulky line frequency iron core transformers.

Many electrical providers (e.g., utility companies that provide grid or mains power) and electrical power distribution systems employ a symmetric three-phase power supply system in which three conductors each carry an AC signal each with the same frequency and voltage (e.g., 60 Hertz (Hz) and 120 volts (V) relative to ground or neutral), but with a phase difference of 120° between the signals. Many residential households use only one or two of these signals, while some industrial applications may use all three.

Three-phase electrical distribution systems provide some advantages. For example three-phase systems may enable a higher power density and may reduce an amount of required wiring. Additionally, a three-phase system is more capable of delivering a more constant or uniform power output, especially to a balanced linear load. Single-phase systems typically utilize a large low-frequency filter to smooth out a more variable power output.

However, many electrical loads are non-linear, especially where non-linear devices such as diodes and transistors are present. For example, input circuitry that includes a half-wave or full-wave rectifier may include large harmonic content, where the current waveform not only includes the fundamental line frequency of 50 or 60 Hz, but higher-order harmonics or multiples of this fundamental frequency. These higher-order harmonics contribute to the apparent power drawn from the mains or grid, but this power is lost or wasted as reactive power, lowering efficiency and resulting in a power factor. Many nations or electrical providers have implemented regulatory schemes that limit the amplitudes of the harmonics of current signals drawn from the mains or grid. To reduce reactive power and comply with such schemes, modern power supplies typically include a power factor correction (PFC) rectifier that is commonly implemented as an interleaved boost converter or a non-interleaved boost converter for single-phase implementations, or as a six-switch boost converter or Vienna rectifier for three-phase implementations. The PFC rectifier is configured to compensate for and thereby decrease the reactive power drawn by the device from the grid.

Efficient power transformation and conversion are of interest, especially with increasing deployment of switched regulators in electrical equipment in applications such as smart grids, telecommunications, battery backups, and electrical vehicular propulsion and charging. Various forms of PFC are commonly adopted to reduce the interference and harmonic content generated by such power systems. For example, vehicle electrification is experiencing rapid growth, and the deployment of vehicle chargers (e.g., fast DC chargers) is needed as part of the charging infrastructure. These vehicle chargers utilize three-phase PFC topologies to deliver power to the vehicle efficiently. Converters for grid energy storage systems (ESSs) and large uninterruptible power supplies (UPSs) for industrial sites and datacenters also require efficient power conversion.

### SUMMARY

Embodiments described herein are directed to power converters utilizing adjustable deadtime control. More particularly, embodiments described herein are directed to power converters utilizing a simplified control scheme that does not require line voltage and current sensors, and increases an operating power range by introducing an adjustable deadtime control between generated pulse width modulation (PWM) gate signals.

Some embodiments of the present disclosure provide a power factor correction circuit. The power factor correction circuit may include a first switching transistor that may include a first gate; a second switching transistor in series with the first switching transistor and that may include a second gate; and a controller configured to generate first and second pulsed signals having respective and complementary phases and separated by an adjustable deadtime and configured to apply the generated first and second pulsed signals to the first and second gates, respectively.

In some embodiments, one or more of the following features may be included. The controller may be configured to generate the first and second pulsed signals having the respective and complementary phases based on an output voltage of the power factor correction circuit. The power factor correction circuit may be configured to receive a single-phase alternating current (AC) power signal as an input. The power factor correction circuit may be configured to receive a multi-phase AC power signal as an input. The power factor correction circuit may include a full bridge rectifier. The power factor correction circuit may include three boost inductors. The controller may be configured to adjust a frequency of pulses of the first and second pulsed signals based on the output voltage of the power factor correction circuit. The first and second switching transistors may be metal-oxide-semiconductor field effect transistors (MOSFETs). The first and second switching transistors may be silicon carbide (SiC) MOSFETs.

Some embodiments of the present disclosure provide a power factor correction circuit. The power factor correction circuit may include a first switching transistor having a first gate; a second switching transistor in series with the first switching transistor and having a second gate; and a controller configured to generate frequency-adjustable first and second pulsed signals having respective and complementary phases separated by an adjustable deadtime. The controller may be configured to adjust a frequency of the first and second pulsed signals and the deadtime separating the first and second pulsed signals based on an output voltage of the power factor correction circuit.

In some embodiments, one or more of the following features may be included. The power factor correction circuit the power factor correction circuit may be configured to receive a single-phase AC power signal as an input. The power factor correction circuit may be configured to receive a multi-phase AC power signal as an input. The power factor correction circuit may include a full bridge rectifier. The power factor correction circuit may include three boost inductors. The first and second switching transistors may be MOSFETs. The first and second switching transistors may be SiC MOSFETs.

Some embodiments of the present disclosure provide a controller for a power factor correction circuit. The power factor correction circuit may be configured to generate frequency-adjustable first and second pulsed signals having respective and complementary phases separated by an adjustable deadtime. The controller may include a comparator, a frequency controller, and a deadtime controller. The controller may be configured to: receive an input signal indicating a measured output voltage of the power factor correction circuit; compare, via the comparator, the measured output voltage with a set point, resulting in a difference between the measured output voltage and the set point; feed the difference into the frequency controller and adjust a frequency of the first and second pulsed signals based on an output of the frequency controller; and provide the difference to the deadtime controller and adjust the deadtime of the first and second pulsed signals based on an output of the deadtime controller.

In some embodiments, one or more of the following features may be included. The frequency controller may include a compensator. The frequency controller may include a voltage-controlled oscillator. The controller may include a pulse-width modulation (PWM) signal generator configured to receive the output of the frequency controller and the output of the deadtime controller.

Some embodiments of the present disclosure provide a power converter configured to receive an AC input signal and output a DC output signal. The power converter may include a first switching transistor having a first gate; a second switching transistor in series with the first switching transistor and having a second gate; and a controller configured to generate first and second pulsed signals having respective and complementary phases and separated by an adjustable deadtime and apply the generated first and second pulsed signals to the first and second gates, respectively.

In some embodiments, one or more of the following features may be included. The controller may be configured to generate the first and second pulsed signals having the respective and complementary phases based on an output voltage of the power factor correction circuit. The input signal may be a single phase input signal. The input signal may be a multi-phase input signal. The power converter may include a full bridge rectifier. The power factor correction circuit may include three boost inductors. The controller may be configured to adjust a frequency of pulses of the first and second pulsed signals based on the output voltage of the power factor correction circuit. The first and second switching transistors may be MOSFETs. The first and second switching transistors may be SiC MOSFETs. The power converter may include a transformer having a primary side coupled to a node between the first and second switching transistors. The power converter may include first and second rectifiers on respective sides of the transformer. The power converter may include a DC/DC converter. The DC/DC converter may include two inductors and a capacitor. The power factor correction circuit may be a first power factor correction circuit, may include a second power factor correction circuit coupled in parallel to an input of the power converter. The power converter may include two DC/DC converters having inputs coupled in series to outputs of the first and second power factor correction circuits. The two DC/DC converters may have outputs coupled in parallel. The two DC/DC converters may have outputs coupled in series.

Some embodiments of the present disclosure provide a power converter configured to receive an AC input signal and output a DC output signal. The power converter may include a first switching transistor having a first gate; a second switching transistor in series with the first switching transistor and having a second gate; and a controller configured to generate first and second pulsed signals having respective and complementary phases and separated by an adjustable deadtime and apply the generated first and second pulsed signals to the first and second gates, respectively. In some embodiments, the power converter may include two DC/DC converters coupled to outputs of the two power factor correction circuits.

Some embodiments of the present disclosure provide a power converter configured to receive an AC power signal as an input. The power converter may include at least one rectifier; a first switching transistor that includes a first gate; a second switching transistor in series with the first switching transistor and that includes a second gate; and a controller configured to generate frequency-adjustable first and second pulsed signals having respective and complementary phases separated by an adjustable deadtime. The controller may be configured to adjust a frequency of the first and second pulsed signals and the deadtime separating the first and second pulsed signals based on an output voltage of the at least one rectifier.

In some embodiments, one or more of the following features may be included. The power converter may be configured to receive a single-phase ac power signal as an input. The power converter may be configured to receive a multi-phase ac power signal as an input. The at least one rectifier may include a full bridge rectifier. The power converter may include a transformer having a primary side coupled to a node between the first and second switching transistors. The at least one rectifier may include first and second rectifiers on respective sides of the transformer. The power converter may include a DC/DC converter. The DC/DC converter may include two inductors and a capacitor. The power factor correction circuit may be a first power factor correction circuit, may include a second power factor correction circuit coupled in parallel to an input of the power converter. The first and second switching transistors may be MOSFETs, and may be SiC MOSFETs.

Some embodiments of the present disclosure provide a power converter configured to receive an AC power signal as an input and output a DC signal as an output. The power converter may include first and second power factor correction circuits, each of which may include first and second switching transistors and a controller configured to drive the first and second switching transistors via frequency-adjustable first and second pulsed signals having respective and complementary phases separated by an adjustable deadtime. The power converter may further include first and second DC/DC converters coupled in series to outputs of the first and second power factor correction circuits.

In some embodiments, one or more of the following features may be included. The power converter may be configured to receive a multi-phase AC power signal as an input. Each power factor correction circuit may include a full bridge rectifier. Outputs of the first and second DC/DC converters may be coupled in parallel or in series. The first and second switching transistors of each power factor correction circuit may be SiC MOSFETs.

Some embodiments of the present disclosure provide a power converter that may include two power factor correction circuits. Each power factor correction circuit may include a respective controller configured to generate frequency-adjustable first and second pulsed signals having respective and complementary phases separated by an adjustable deadtime. Each controller may include a respective comparator, a frequency controller, and a deadtime controller. Each controller may be configured to receive an input signal indicating a measured output voltage of the respective power factor correction circuit; compare, via the comparator, the measured output voltage with a set point, resulting in a difference between the measured output voltage and the set point; feed the difference into the frequency controller and adjust a frequency of the first and second pulsed signals based on an output of the frequency controller; and provide the difference to the deadtime controller and adjust the deadtime of the first and second pulsed signals based on an output of the deadtime controller.

In some embodiments, one or more of the following features may be included. Each frequency controller may include a compensator or a voltage controlled oscillator. Each controller may include a PWM signal generator configured to receive the output of the respective frequency controller and the output of the respective deadtime controller.

Some embodiments of the present disclosure provide a power converter configured to receive an AC input signal and output a DC output signal. The power converter may include a transformer and a power factor correction circuit. The power factor correction circuit may include a first switching transistor having a first gate; a second switching transistor in series with the first switching transistor and having a second gate; and a controller configured to generate first and second pulsed signals having respective and complementary phases and separated by an adjustable deadtime and apply the generated first and second pulsed signals to the first and second gates, respectively. A primary side of the transformer may be coupled to a node between the first and second switching transistors.

In some embodiments, one or more of the following features may be included. The power converter may include first and second rectifiers on respective sides of the transformer. The input signal may be a single phase input signal. The input signal may be a multi-phase input signal. The controller may be configured to adjust a frequency of pulses of the first and second pulsed signals based on the output voltage of the power factor correction circuit. The first and second switching transistors may be SiC MOSFETs.

Some embodiments of the present disclosure provide a power converter configured to receive an AC power signal as an input. The power converter may include at least one rectifier; a first switching transistor may include a first gate; a second switching transistor in series with the first switching transistor and may include a second gate; and a controller configured to generate frequency-adjustable first and second pulsed signals having respective and complementary phases separated by an adjustable deadtime. The controller may be configured to adjust a frequency of the first and second pulsed signals and the deadtime separating the first and second pulsed signals based on an output voltage of the at least one rectifier.

In some embodiments, one or more of the following features may be included. The power converter may be configured to receive a single-phase AC power signal as an input. The power converter may be configured to receive a multi-phase AC power signal as an input. The at least one rectifier may include a full bridge rectifier. The power converter may include a transformer having a primary side coupled to a node between the first and second switching transistors. The at least one rectifier may include first and second rectifiers on respective sides of the transformer. The power converter may include a DC/DC converter. The DC/DC converter may include two inductors and a capacitor. The power factor correction circuit may be a first power factor correction circuit, and the power converter may include a second power factor correction circuit coupled in parallel with the first power factor correction circuit to an input of the power converter. The first and second switching transistors may be SiC MOSFETs.

Some embodiments of the present disclosure provide a power converter. The power converter may include a transformer. The power converter may include first and second rectifiers on respective first and second sides of the transformer. The power converter may include a power factor correction circuit that includes a controller configured to generate frequency-adjustable first and second pulsed signals having respective and complementary phases separated by an adjustable deadtime. The controller may include a comparator, a frequency controller, and a deadtime controller. The controller may be configured to: receive an input signal may include a measured output voltage of the power factor correction circuit; compare, via the comparator, the measured output voltage with a set point, resulting in a difference between the measured output voltage and the set point; feed the difference into the frequency controller and adjust a frequency of the first and second pulsed signals based on an output of the frequency controller; and provide the difference to the deadtime controller and adjust the deadtime of the first and second pulsed signals based on an output of the deadtime controller.

In some embodiments, one or more of the following features may be included. the first and second pulsed signals respectively drive gates of first and second switching transistors located on the first side of the transformer. The frequency controller may include a compensator or a voltage controlled oscillator. The controller may include a PWM signal generator configured to receive the output of the frequency controller and the output of the deadtime controller.

### BRIEF DESCRIPTION OF THE DRAWINGS

The accompanying figures are included to provide a further understanding of the present invention, and are incorporated in and constitute a part of this specification. The drawings illustrate some embodiments of the present invention and, together with the description, serve to explain principles of the present invention.

FIG. 1 is a circuit diagram of a single-phase power factor correction circuit according to some aspects of the present disclosure.

FIG. 2 is a circuit diagram of a multi-phase power factor correction circuit according to some aspects of the present disclosure.

FIG. 3A is a block diagram illustrating aspects of a controller used to control a power factor correction circuit, such as those of FIGS. 1 and 2. FIGS. 3B and 3C illustrate aspects of adjustable deadtime control.

FIG. 4 is a flowchart illustrating operations of a controller such as that of FIG. 3A.

FIGS. 5A and 5B illustrate simulated output of the circuit of FIG. 2

FIGS. 6A and 6B are diagrams illustrating applications of the circuit of FIG. 2 according to some embodiments of the present disclosure.

FIG. 7 is a circuit diagram illustrating aspects of current sensing in the applications of FIGS. 6A and 6B.

FIG. 8 is a block diagram illustrating aspects of a controller used to control some of the circuits in FIGS. 6A and 6B using droop control for output current balancing.

FIG. 9 is a block diagram illustrating aspects of a controller used to control some of the circuits in FIGS. 6A and 6B using droop control for input voltage balancing.

FIG. 10 is a circuit diagram of a single-phase unidirectional AC/DC converter according to some aspects of the present disclosure.

FIG. 11 is a circuit diagram of a multi-phase unidirectional AC/DC converter according to some aspects of the present disclosure.

FIGS. 12A and 12B illustrate simulated input and output, respectively, of the circuit of FIG. 10.

### DETAILED DESCRIPTION

The present inventive concepts now will be described more fully hereinafter with reference to the accompanying drawings, in which illustrative embodiments of the inventive concepts are shown. In the drawings, the relative sizes of regions or features may be exaggerated for clarity. These inventive concepts may, however, be embodied in many different forms and should not be construed as limited to the embodiments set forth herein; rather, these embodiments are provided so that this disclosure will be thorough and complete, and will fully convey the scope of the inventive concepts to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

Well-known functions or constructions may not be described in detail for brevity and/or clarity.

As used herein the expression “and/or” includes any and all combinations of one or more of the associated listed items.

The terminology used herein is for the purpose of describing particular embodiments only and is not intended to be limiting of the inventive concepts. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the inventive concepts disclosed herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As discussed above, modern power supplies typically include a power factor correction (PFC) rectifier that is either implemented as an interleaved boost converter or a non-interleaved boost converter for single-phase implementations, or as a six-switch boost converter or Vienna rectifier for three-phase implementations. The PFC rectifier is configured to compensate for lagging current (that is, a current signal that lags a voltage signal) and thereby decrease the reactive power drawn by the device from the grid. These typical implementations typically require a large number of devices and/transistors, and thus single-stage implementations have also been proposed to reduce the cost and/or increase the power density. For example, a single-stage PFC boost rectifier for either single-phase or three-phase power that uses only two switches has been proposed. While these devices also may exhibit high power factors and low current total harmonic distortions (THD), they also require complicated control schemes and relatively large numbers of current and voltage sensors, thus limiting their benefits. Furthermore, such devices are limited to certain load conditions and thus also are limited in their benefits.

Accordingly, the present disclosure provides a simplified control scheme that does not require line voltage and current sensors, and increases an operating power range by introducing an adjustable deadtime control between generated pulse width modulation (PWM) gate signals, as described in greater detail below. As used herein, deadtime may refer to a spacing or time duration between a falling edge of a first gate signal and a rising edge of a second signal.

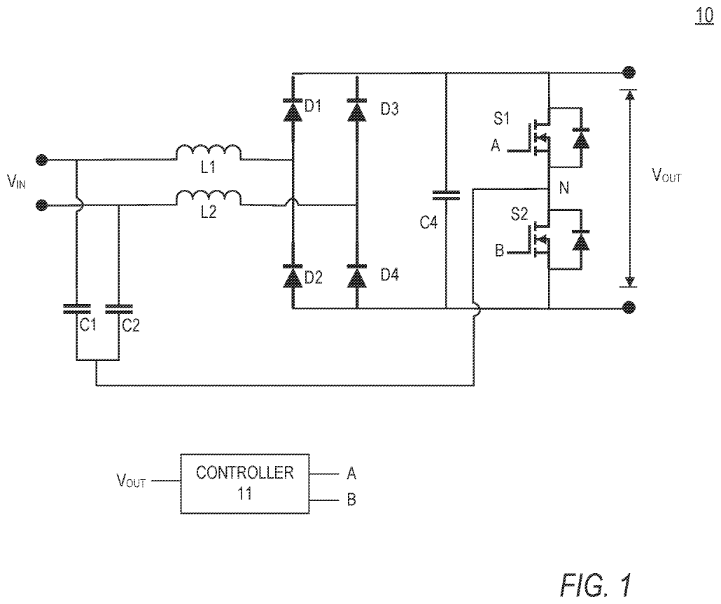

FIG. 1 is a circuit diagram of a single-phase power factor correction circuit that is part of an AC/DC converter or rectifier 10, according to some aspects of the present disclosure. The rectifier 10 may take an AC signal V_{IN} as input and output a DC signal V_{OUT}. In some embodiments, the AC input signal V_{IN} may be a single phase of a multi-phase AC power signal.

The AC/DC rectifier 10 may include an input rectification circuit comprising diodes D1-D4. The AC/DC rectifier 10 may also include a two-switch PFC circuit comprising boost inductors L1 and L2, differential-mode filter capacitances C1 and C2, and first and second PFC switches S1 and S2. The first and second PFC switches S1 and S2 may be controlled by a controller 11. The AC/DC rectifier 10 may also include a DC link capacitance C4.

The input rectification circuit is illustrated as a full wave bridge rectifier comprising four diodes D1-D4, though the present disclosure is not limited thereto. In some embodiments, the input rectification circuit may include a half wave bridge rectifier. The input rectification circuit may be configured to convert the AC input signal V_{IN} into a DC signal.

The first PFC switch S1 may have a first terminal coupled to the positive side of the input rectification circuit, and a second terminal coupled to a first node N. The second PFC switch S2 may have a first terminal coupled to the first node N and a second terminal coupled to the negative side of the input rectification circuit. The first and second PFC switches S1 and S2 may be metal-oxide-semiconductor field effect transistors (MOSFETs), though the present disclosure is not limited thereto. In some embodiments, the PFC switches S1 and S2 may be silicon carbide (SiC) devices, e.g., SiC MOSFETS. SiC devices may offer higher breakdown voltages and lower switching losses, and therefore may allow higher efficiencies at the frequencies of interest in the present disclosure. In some embodiments, the diodes D1-D4 of the input rectification circuit may also be SiC devices.

The boost inductors L1 and L2 may be connected between the input terminals and the input rectification circuit. In the circuit of FIG. 1, S1 is switched on to build only positive current in inductors L1 or L2 through rectifier diodes D1-D4 when L1 or L2 is connected to positive voltage terminal and S2 is switched on to build only negative current through rectifier diodes D1-D4 in inductor L1 or L2 when L1 or L2 is connected to negative voltage terminal. Therefore, the boost inductors L1 or L2 carry positive current when the input terminal is positive, while the boost inductor L1 or L2 carry negative current when the input terminal is negative. During the time when switch S1 is OFF, the stored energy in the inductors L1 or L2 is delivered to capacitor C4 when the corresponding input terminal is positive, whereas the stored energy in the inductors L1 or L2 is delivered to capacitor C4 during the time when switch S2 is OFF if the corresponding input terminal is negative.

The output voltage V_{OUT} may be measured by a voltage sensor (not shown) either across the capacitor C4 or at the output terminals.

The capacitances C1 and C2 are connected respectively between the positive and negative input terminals and the first node N, and are used to create a virtual neutral at the first node N. Accordingly, decoupling of the input current may be achieved, which may reduce the THD and increase the power factor.

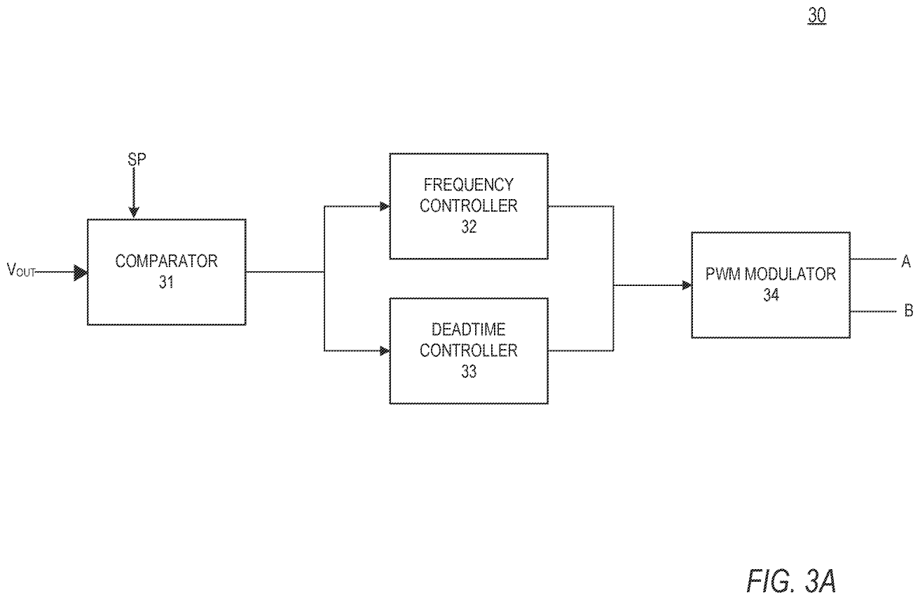

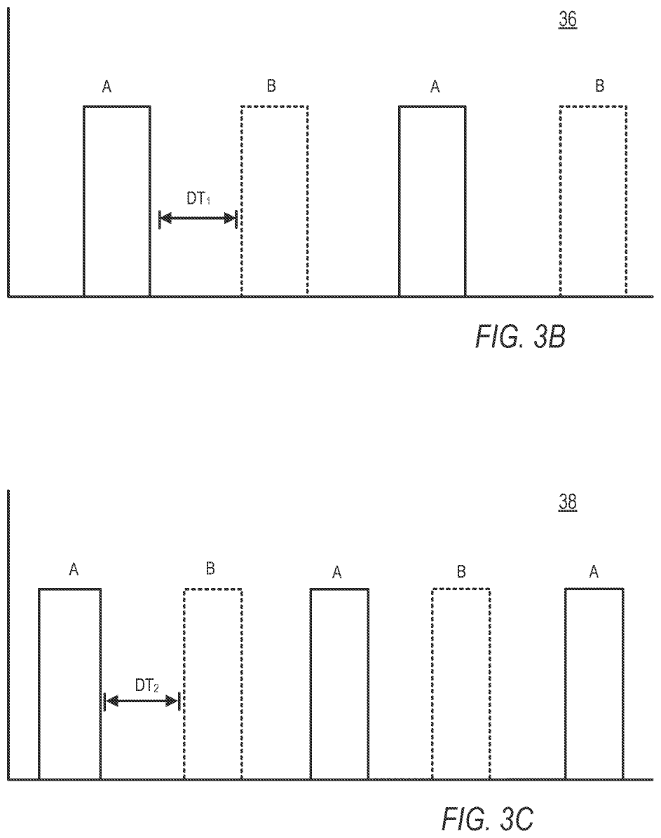

A controller 11 may generate signals A and B that are applied respectively to the first PFC switch S1 (e.g., a gate of the first PFC switch S1) and the second PFC switch S2 (e.g., a gate of second PFC switch S2) in response to the output voltage V_{OUT}. In other words, the controller 11 may generate first and second signals A and B applied respectively to the first and second gates of respective first and second PFC switches S1 and S2. The controller may be configured to drive (e.g., activate so as to be conducting) the PFC switches S1 and S2 in a complementary manner, or in other words, drive at most one of the first PFC switch S1 and the second PFC switch S2 at a single time. The PFC switches S1 and S2 may be driven using a PWM-based control scheme and according to a variable frequency selected based on the measured output voltage V_{OUT} provided as part of a feedback control and/or closed loop control. In some embodiments, the PFC switches S1 and S2 may be driven by respective signals having complementary phases generated by the controller 11 according to the selected variable frequency with a duty cycle of approximately 50%, though the present disclosure is not limited thereto. Additionally, an adjustable deadtime control where neither the first switch S1 and the second switch S2 are driven may be determined by the controller 11 to both limit the input power and also provide zero voltage switching (ZVS). Further detail of the adjustable deadtime control is provided below with respect to FIG. 3.

ZVS may enable faster switching frequency at higher input voltage and voltage drop, and provides “soft switching,” which may reduce switching losses in the first and second PFC switches S1 and S2. In contrast, “hard switching” occurs when an overlap between voltage and current is present in switches (e.g., MOSFETs) that are switching on or off. Using soft switching/ZVS, the voltage in the switch S1 or S2 is allowed to reduce to zero before the switch is turned on or off, eliminating and/or reducing any overlap between voltage and current, thus minimizing losses.

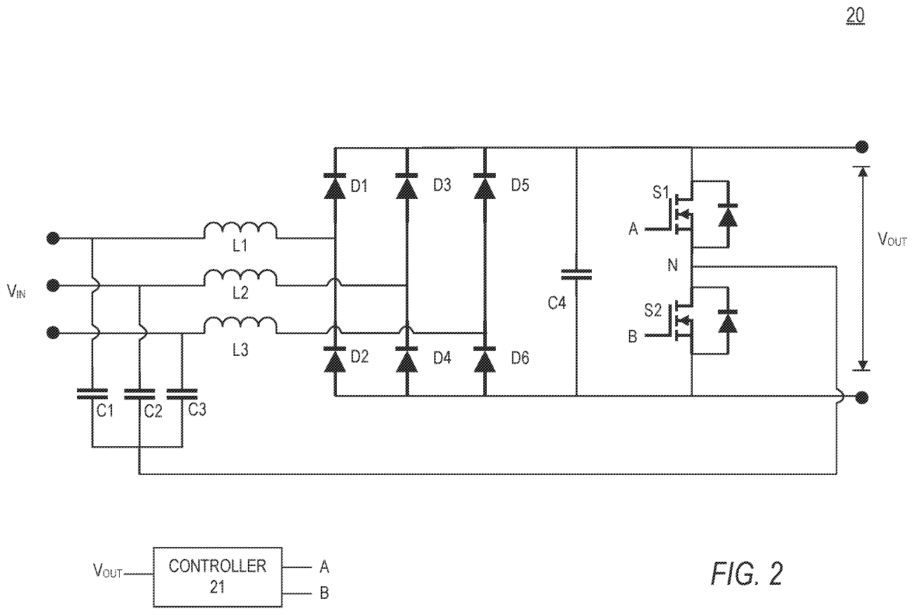

FIG. 2 is a circuit diagram of a multi-phase power factor correction circuit provided as part of an AC/DC rectifier 20 according to some aspects of the present disclosure. The rectifier 20 may take a multi-phase AC signal V_{IN} as input and output a DC signal V_{OUT}.

The AC/DC rectifier 20 may include an input rectification circuit comprising diodes D1-D6. The AC/DC rectifier 20 may also include a two-switch PFC circuit comprising three boost inductors L1-L3, three differential-mode filter capacitances C1-C3, and first and second PFC switches S1 and S2. The first and second PFC switches S1 and S2 may be controlled by a controller 21. The AC/DC rectifier 20 may also include a DC link capacitance C4.

The input rectification circuit is illustrated as a full wave bridge rectifier comprising six diodes D1-D6, though the present disclosure is not limited thereto. In some embodiments, the input rectification circuit may include a half wave bridge rectifier. The input rectification circuit may be configured to convert the AC input signal V_{IN} into a DC signal.

The first PFC switch S1 may have a first terminal coupled to the positive side of the input rectification circuit, and a second terminal coupled to a first node N. The second PFC switch S2 may have a first terminal coupled to the first node N and a second terminal coupled to the negative side of the input rectification circuit. As with FIG. 1, the first and second PFC switches S1 and S2 may, in some embodiments, be MOSFETs and may be SiC MOSFETs.

The boost inductors L1-L3 are coupled between the input terminals and the input rectification circuit. In the circuit of FIG. 2, S1 is switched on to build only positive current in inductors L1-L3 through rectifier diodes D1-D6 when the corresponding boost inductor is connected to a positive voltage terminal, and S2 is switched on to build only negative current through rectifier diodes D1-D6 in inductor L1-L3 when the corresponding boost inductor is connected to a negative voltage terminal. Therefore, the boost inductors L1-L3 carry positive current in positive voltage cycle segments, while the boost inductors L1-L3 carry negative current in negative voltage cycle segments. During the time when the first PFC switch S1 is OFF, the stored energy in the boost inductors L1-L3 connected to positive phase voltages is delivered to capacitor C4, whereas the stored energy in boosted inductors L1-L3 connected to negative phase voltages is delivered to capacitor C4 during the time when the second PFC switch S2 is OFF. Due to high frequency switching and/or variable frequency control, a size of capacitor C4 can also be reduced to achieve a same DC link voltage ripple as is found in other PFC rectifiers. The output voltage V_{OUT} may be measured by a voltage sensor (not shown) either across the capacitor C4 or at the output terminals.

The capacitances C1-C3 are connected between the respective ones of the input terminals and the first node N, and are used to create a virtual neutral at the first node N. Accordingly, decoupling of the input currents may be achieved, which may reduce the THD and increase the power factor.

A controller 21 may generate signals A and B that are applied respectively to the first PFC switch S1 (e.g., the gate of the first PFC switch S1) and the second PFC switch S2 (e.g., the gate of the second PFC switch S2) in response to the output voltage V_{OUT}. In other words, the controller 21 may generate first and second signals A and B applied respectively to the first and second gates of respective first and second PFC switches S1 and S2. The controller may be configured to drive the first and second PFC switches S1 and S2 in a complementary manner, or in other words, drive at most one of the first PFC switch S1 and the second PFC switch S2 at a single time. The switches may be driven using a pulse-width modulation based control scheme and according to a variable frequency selected based on the output voltage V_{OUT} provided as part of a feedback control. In some embodiments, the first and second PFC switches S1 and S2 may be driven according to the selected variable frequency with a duty cycle of approximately 50%, though the present disclosure is not limited thereto. Additionally, an adjustable deadtime time period where neither the first switch S1 and the second switch S2 are turned on may be provided to both limit the input power and also provide zero voltage switching (ZVS).

FIG. 3A is a block diagram illustrating aspects of a controller 30 used to control a power factor correction circuit, such as controllers 11 and 21 of FIGS. 1 and 2. The controller 30 may receive as an input a signal comprising a measured output voltage of the rectifier 10 or 20 (e.g. V_{OUT}). In some embodiments, the output voltage V_{OUT} may be measured by a voltage sensor and/or circuit. The measured output voltage may be compared with a set point SP in comparator 31, and an error or difference between the measured output voltage and the set point SP may be obtained. The error may be then fed into a frequency controller 32, which in some embodiments may include a compensator such as a two pole two zero (2P2Z) compensator or proportional-integral (PI) compensator. In some embodiments, the frequency controller 32 may include a voltage controlled oscillator (VCO).

The output of the comparator 31 may also be provided to an adjustable deadtime controller 33, which may generate a deadtime period that occurs between a driving signal A applied to the first gate of the first PFC switch S1 and a driving signal B applied to the second gate of the second PFC switch S2. For example, as discussed above, in some embodiments the gate signals A and B applied to each of the first and second PFC switches S1 and S2 may be complementary PWM signals with 50% duty cycles. Thus, if no deadtime period were provided, one or the other of the first and second PFC switches S1 and S2 would be switched on (and in some brief instances, both may be switched on, given that there are switching delays). The adjustable deadtime controller 33 may therefore provide an adjustable deadtime period between when the signal A applied to the first PFC switch S1 is activating or high and when the signal B applied to the second PFC switch S2 is activating or high, depending on the difference between the output voltage V_{OUT} and the set point SP. For example, with reference to waveforms 36 and 38 of FIGS. 3B and 3C adjustable deadtime controller 33 may adjust a deadtime from a first value DT₁ to a second value DT₂. Deadtime adjustment and frequency control can either work together or independently to control output voltage.

The output of the frequency controller 32 and the adjustable deadtime controller 33 may be provided to a PWM modulator or signal generator 34, which is configured to generate the signals A and B. The signals A and B may then be applied to the first and second PFC switches S1 and S2.

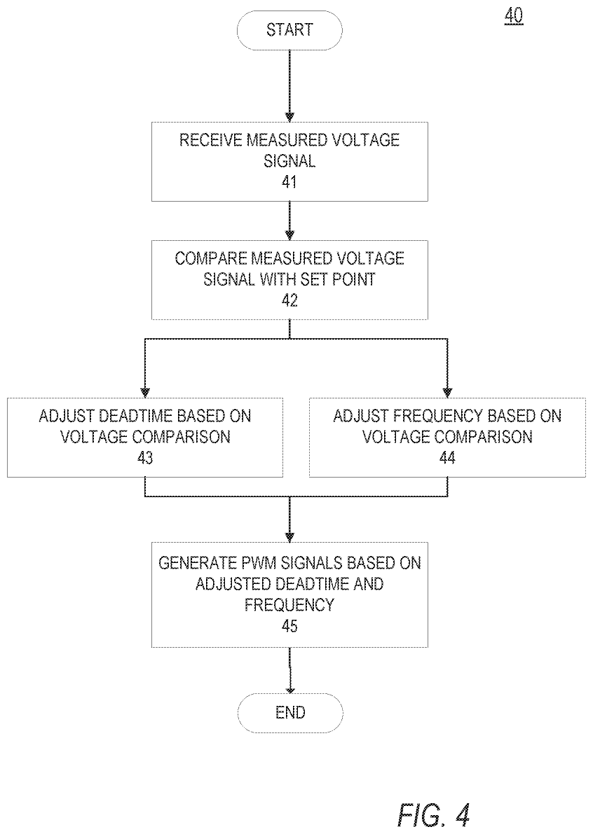

FIG. 4 is a flowchart illustrating operations of a controller such as that of FIG. 3. In some embodiments, a method 40 of controlling a power converter or rectifier may include receiving as an input a signal comprising a measured output voltage of the rectifier (block 41). The output voltage may be measured by a voltage sensor and/or circuit configured to supply the signal to the controller. The measured output voltage may be compared with a set point SP by the controller (block 42), and an error or difference between the measured output voltage and the set point SP may be obtained. As discussed above, the error may be then fed into a frequency controller configured to generate and/or adjust a frequency output (block 43).

The error or difference may also be provided to an adjustable deadtime controller (block 44), which may be configured to generate and/or adjust a deadtime value or spacing value between a first signal to be applied to the first PFC switch S1 and the second gate signal applied to the second PFC switch S2. PWM signals or pulses may be generated based on the adjusted or generated frequency output and the adjusted or generated deadtime value (block 45).

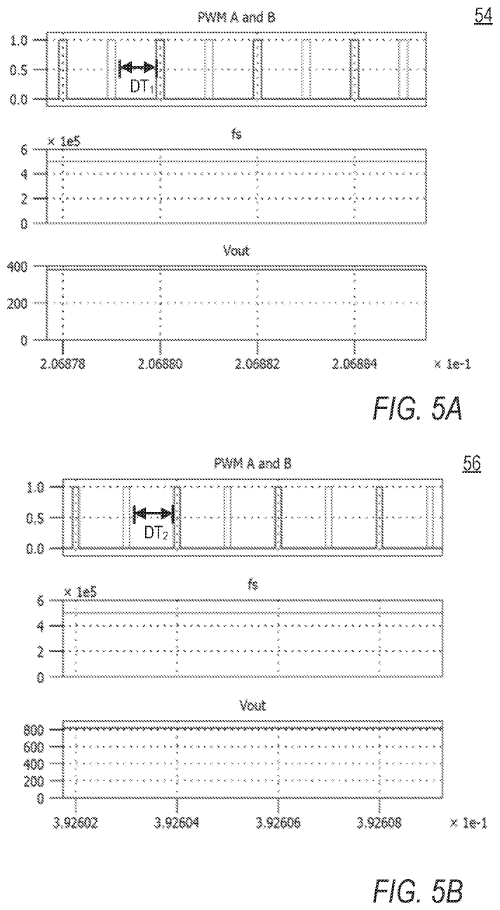

The proposed circuit may operate at 480 V (AC) input line to line voltage (e.g., V_{IN}), with a THD of less than 5%. In some embodiments, the voltage output and/or the voltage across capacitor C4 (or the DC link voltage) may be up to 820 V DC, and an operating power of up to 6 kW (kilowatts) may be achieved. FIGS. 5A and 5B illustrate simulated outputs of the circuit of FIG. 2. In FIG. 5A, the circuit is simulated as operating at a 200 V (AC) input line to line voltage (e.g., V_{IN}), with a switching frequency of 50 kHz and an output regulated at 380 V DC. The adjustable deadtime control may provide an adjustable deadtime DT₁ of approximately 832 nanoseconds (ns) of deadtime between PWM signals for A and B. Test results are in accordance with the simulated results. In FIG. 5B, the circuit is simulated as operating at a 400 V (AC) input line to line voltage (e.g., V_{IN}), with a switching frequency of 50 kHz and an output regulated at 820 V DC. The adjustable deadtime control may provide an adjustable deadtime DT₂ of approximately 882 ns of deadtime between PWM signals for A and B.

In view of the above, the present disclosure provides a control scheme for PFC rectifiers that use a fewer number of active switches than the conventional Vienna or six-switch rectifiers, reducing both component cost and complexity. The control scheme uses adjustable deadtime control within a closed loop control based on a measured voltage output signal, and as such a fewer number of sensors and voltage/current measurements may be used. The first and second PFC switches S1 and S2 may be driven using ZVS, which may reduce switching losses during operation. High operating frequencies of up to 500 kHz (kilohertz) may be achievable using SiC or other wide bandgap devices. The adjustable deadtime control disclosed herein also provides an increased power operating range and is not limited to an upper portion (e.g., greater than 50%) of a load range. The proposed control method limits the input power by introducing dead time control. Stated differently, the proposed control disclosed herein may enable the PFC circuit to operate in a range from no load to full load, e.g., 60%, 70%, 80%, 90%, or 100% of a load range.

In some embodiments, the circuits of FIG. 1 and FIG. 2 may be implemented in a relatively compact printed circuit board (PCB) assembly, with costs of approximately 50% as compared to related converter circuits. Greater life expectancy and improved mean time between failure is also predicted.

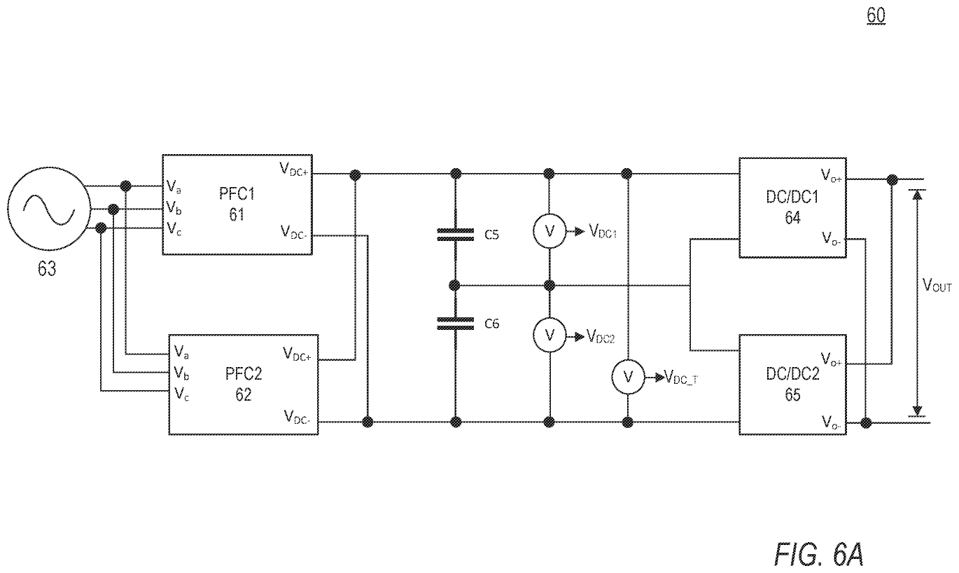

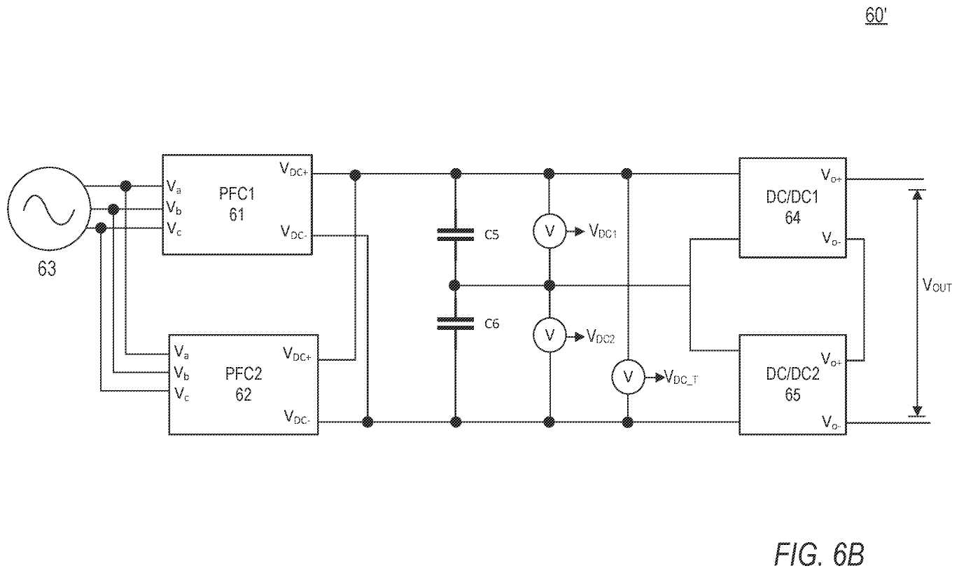

The converter/rectifiers 10 and 20 of FIGS. 1 and 2, and the control scheme discussed with reference to FIGS. 3-5 may be used in various applications. For example, FIGS. 6A and 6B are diagrams illustrating applications of the circuit of FIG. 2 according to some embodiments of the present disclosure. FIGS. 6A and 6B respectively show topologies 60/60′ comprising first and second multi-phase PFC boost circuits 61 and 62 that are coupled in parallel to a main/grid multi-phase power source 63. The multi-phase PFC boost circuits 61 and 62 may each include the circuit 20 of FIG. 2. Additionally, the topologies 60 and 60′ of FIGS. 6A and 6B include two DC/DC converter modules or “bricks” 64 and 65 that are coupled to the outputs of the multi-phase PFC boost circuits 61 and 62. In FIG. 6A, the two DC/DC converter modules 64 and 65 are coupled in series on input and in parallel on output, and in FIG. 6B, the two DC/DC converter modules 64 and 65 are coupled in series on both input and output.

In some embodiments, the DC/DC converter modules 64 and 65 may be LLC resonant DC/DC converters. Converters incorporating LLC resonant tank circuits may be used as part of power conversion systems. An LLC resonant tank circuit (also referred to herein as an LLC resonant circuit) may include a capacitor (C), a first inductor (L) and a second inductor (L) for providing an output voltage of the power conversion system. The LLC resonant tank circuit may include series resonant circuits, in which the capacitor and first inductor are in series with the second inductor, which may be an inductor of a transformer. Greater discussion of LLC resonant DC/DC circuits may be found in U.S. Pat. No. 10,804,812, assigned to the same applicant as the present disclosure and incorporated by reference as if set forth herein.

The topologies 60 and 60′ of FIGS. 6A and 6B also include voltage sensors and/or circuits for measuring the voltage V_{DC1} input of the first DC/DC brick 64, the voltage V_{DC2} input of the second DC/DC circuit 65, and the total voltage output from the parallel coupled PFC circuits V_{DC_T}. Filter capacitances C5 and C6 are also shown.

Each of the PFC boost circuits 61 and 62 and each of the DC/DC bricks 64 and 65 may be controlled using the control scheme disclosed herein. In other words a controller configured to control each of the PFC boost circuits 61 and 62 and each of the DC/DC bricks 64 and 65 may include receiving as an input a signal comprising a measured output voltage of the corresponding rectifier or converter. The output voltage may be measured by a voltage sensor configured to supply the signal to a controller. The measured output voltage may be compared with a set point SP or V_{REF} for the corresponding rectifier or converter by the controller, and an error or difference between the measured output voltage and the set point SP/V_{REF} may be obtained. As discussed above, the error may be then fed into a frequency controller configured to generate and/or adjust a frequency output for the corresponding rectifier or converter. The error or difference may also be provided to an adjustable deadtime controller, which may be configured to generate and/or adjust a deadtime duration or spacing period between a first signal to be applied to a first PFC switch S1 and the second signal applied to a second PFC switch S2 (or switches of the DC/DC bricks 64 and 65) for the corresponding rectifier or converter. PWM signals or pulses may be generated based on the adjusted or generated frequency output and the adjusted or generated deadtime value by the controller for the corresponding rectifier or converter.

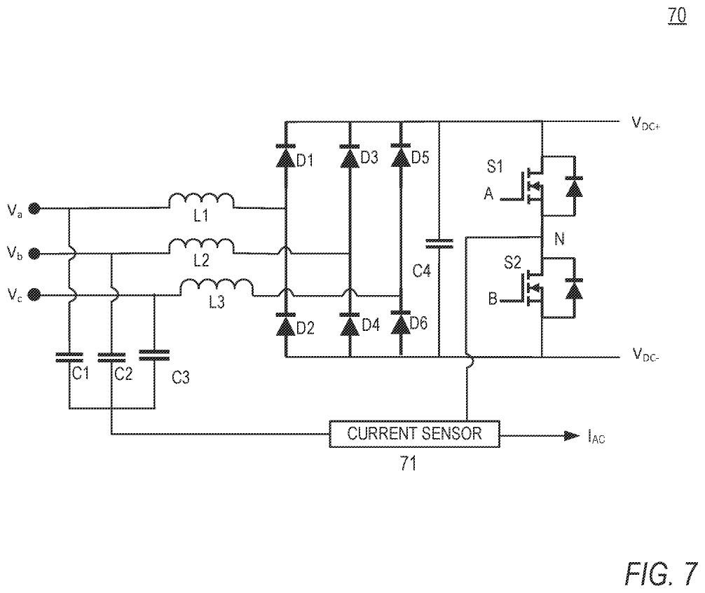

Additionally, power balancing of the first and second PFC boost circuits 61 and 62 and the two DC/DC bricks 64 and 65 may be provided by a control scheme using droop control and current sensing of the alternating current from the neutral point (node N) between switches S1 and S2. FIG. 7 is a circuit diagram illustrating aspects of a rectifier 70 incorporating current sensing in the applications of FIGS. 6A and 6B. The rectifier 70 may be used to replace one or more of the PFC boost circuits 61 and 62 in FIGS. 6A and 6B. As seen in FIG. 7, a current sensor 71 may be implemented at the neutral point (node N) between first and second PFC switches S1 and S2. This signal can be used for power balancing, for example because it may be positively correlated with the PFC power signal.

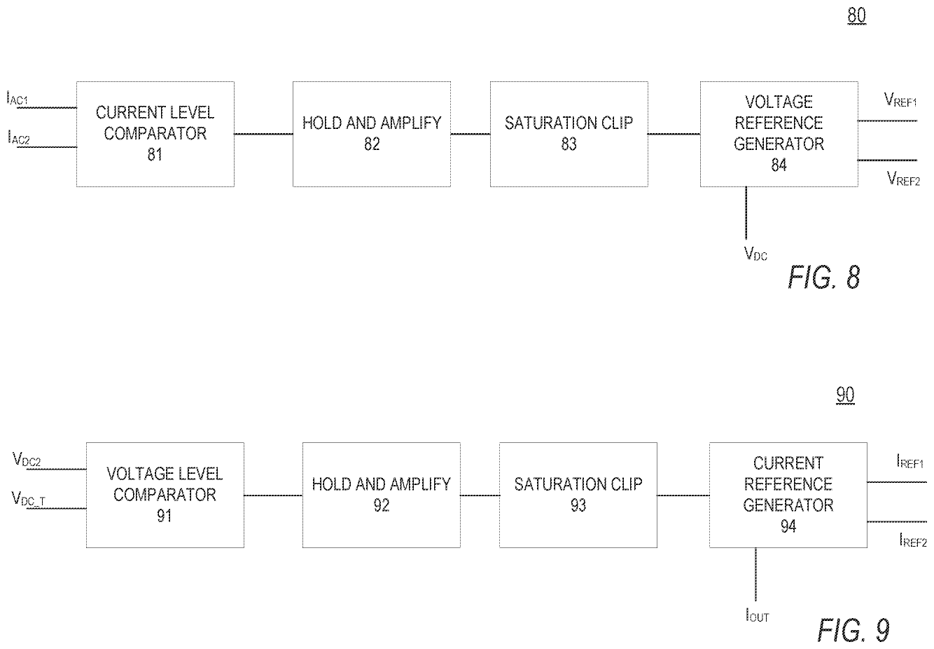

FIG. 8 is a block diagram illustrating aspects of a controller 80 used to control some of the circuits in FIGS. 6A and 6B using droop control for output current balancing (e.g., PFC boost circuit power). As can be seen in the block diagram of controller 80, an output current I_{AC1} and I_{AC2} of each of the PFC boost circuits 61 and 62 may be provided to a current level comparator 81. A difference or offset between the output currents I_{AC1} and I_{AC2} of the PFC boost circuits 61 and 62 may be obtained. The resultant value may be stored in a hold and amplify 82 that includes a hold (e.g., in a zero-order hold) and amplifier. The amplified resultant value may be compared with minimum and maximum values and clipped accordingly by saturation clip 83, and the result may be provided to a voltage reference generator 84 configured to provide respective voltage references for the first and second PFC boost circuit 61 and 62 based on the voltage output of the first and second PFC boost circuits 61 and 62 (V_{DC}).

When the output current of the first PFC boost circuit 61 is greater than the output current of the second PFC boost circuit 62, the voltage reference for the first PFC boost circuit 61 may be reduced, resulting in a change or adjustment to the operating frequency and/or adjustable deadtime by controller 21 thereof. The change or adjustment to the operating frequency and/or adjustable deadtime results in a decrease in the output current of the first PFC boost circuit 61, reducing a difference between the output currents of the first and second PFC boost circuits 61 and 62 and bringing the two in balance. Similarly, when the output current of the second PFC boost circuit 62 is greater than the output current of the first PFC boost circuit 61, the voltage reference for the second PFC boost circuit 62 may be reduced, resulting in a change or adjustment to the operating frequency and/or adjustable deadtime by controller 21 thereof. The change or adjustment to the operating frequency and/or adjustable deadtime of the second PFC boost circuit 62 results in a decrease in the output current of the second PFC boost circuit 62, reducing a difference between the output currents of the first and second PFC boost circuits 61 and 62 and bringing the two in balance.

FIG. 9 is a block diagram illustrating aspects of a controller 90 used to control some of the circuits in FIGS. 6A and 6B using droop control for input voltage balancing. As can be seen in the block diagram of controller 90, an input voltage of one of the DC/DC bricks 64 and 65 (e.g., V_{DC1} or V_{DC2}), along with a total (DC link) voltage V_{DC_T} may be provided to a voltage level comparator 91. In some embodiments, the input voltages of both of the DC/DC bricks 64 and 65 (e.g., V_{DC1} and V_{DC2}) may be provided to the voltage level comparator 91. A difference or offset between the total input voltage of the DC/DC bricks 64 and 65 (V_{DC_T}) may be compared with the two times the input voltage of the one DC/DC brick 64 and 65 (e.g., V_{DC1} or V_{DC2}). The resultant value may be stored in a hold and amplify 92 that includes a hold (e.g., in a zero-order hold) and amplifier. The amplified resultant value may be compared with minimum and maximum values and clipped accordingly by saturation clip 93, and the result may be provided to a current reference generator 94 configured to provide respective current references for the DC/DC bricks 64 and 65.

When twice the input voltage of a first of the DC/DC bricks 64, 65 is greater than the total input voltage of the DC/DC bricks 64 and 65, the current reference for the first DC/DC brick 64 may be increased, resulting in a change or adjustment to the operating frequency and/or adjustable deadtime by a controller thereof. The change or adjustment to the operating frequency and/or adjustable deadtime period results in a decrease in the input voltage of the first DC/DC brick 64, reducing a difference between the input voltages of the DC/DC bricks 64 and 65 and bringing the two in balance. Similarly, when twice the input voltage of a second of the DC/DC bricks 65 is greater than the total input voltage of the DC/DC bricks 64 and 65, the current reference for the second DC/DC brick 65 may be increased, resulting in a change or adjustment to the operating frequency and/or adjustable deadtime by a controller thereof. The change or adjustment to the operating frequency and/or adjustable deadtime results in a decrease in the input voltage of the second DC/DC brick 65, reducing a difference between the input voltages of the DC/DC bricks 64 and 65 and bringing the two in balance.

In some embodiments, the topologies disclosed in FIGS. 6A and 6B and controlled according to FIGS. 3-5 and 7-9 may operate at 360 V AC input line to line voltage and provide an output (DC link) voltage of 800 V. An operating power may be up to 6.4 kW. Furthermore, the PFC boost circuits 61 and 62 and DC/DC bricks 64 and 65 may be initially unbalanced due to component differences, and with the droop control disclosed herein, the PFC boost circuits 61 and 62 and DC/DC bricks 64 and 65 may eventually become balanced. As discussed above, among the applications for the PFC boost circuits 61 and 62 and DC/DC bricks 64 and 65 adjustable deadtime control disclosed herein may include battery chargers or other electrical power conversion devices. The topologies disclosed herein may enable compact charger and device designs with wide output voltage ranges, enabling a greater range of applications.

The present disclosure is not limited to providing two PFCs and two DC/DC bricks, and greater and unequal numbers of each may be provided.

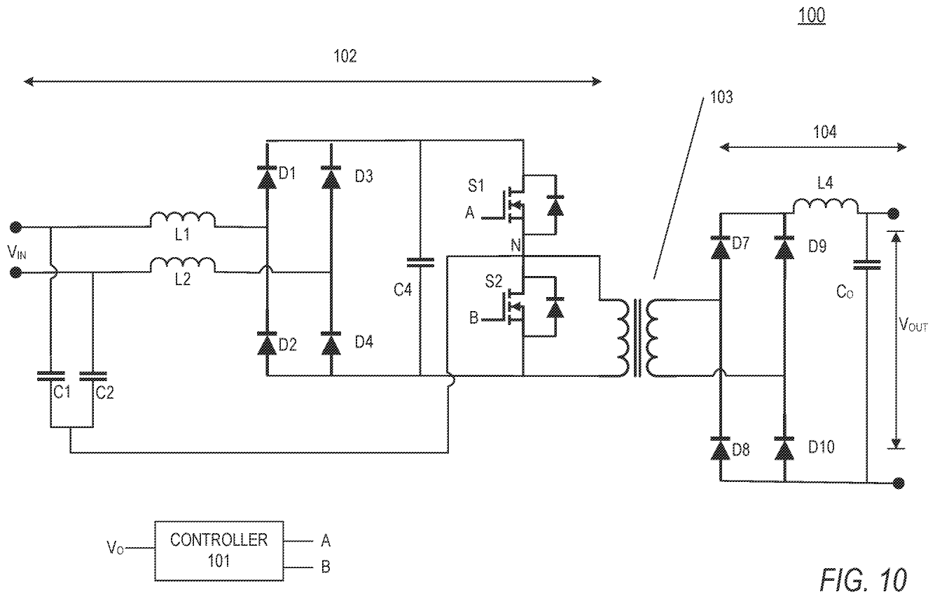

Other power conversion topologies are provided by the PFCs of FIGS. 1-2 and the control schemes discussed herein. FIG. 10 is a circuit diagram of a single-phase unidirectional AC/DC converter according to some aspects of the present disclosure. As can be seen in FIG. 10, the topology 100 may include the PFC of FIG. 1 (referred to as PFC 102) controlled by controller 101 as discussed with reference to FIGS. 3A-C and 4.

A primary side of a transformer 103 may be between the neutral point (node N) of the first and second PFC switches S1 and S2, and a rectification circuit 104 may be provided on the secondary side of the transformer 103.

The rectification circuit 104 is illustrated as a full wave bridge rectifier comprising four diodes D7-D10, though the present disclosure is not limited thereto. In some embodiments, the rectification circuit 104 may include a half wave bridge rectifier. The rectification circuit 104 may be configured to convert the input signal supplied by the transformer 103 into a DC signal. A filter comprising inductor L4 and capacitor C_{O} is also shown.

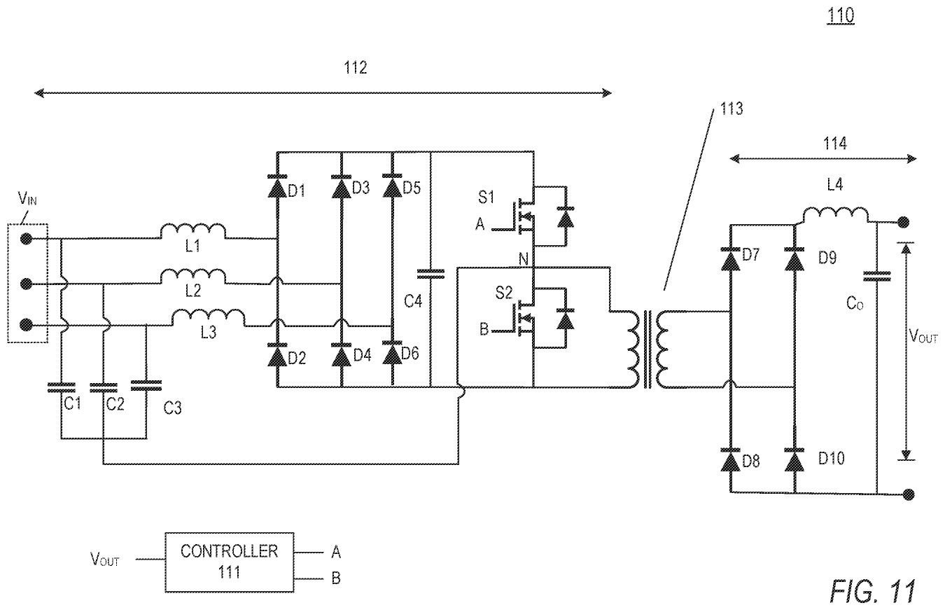

FIG. 11 is a circuit diagram of a multi-phase unidirectional AC/DC converter according to some aspects of the present disclosure. As can be seen in FIG. 11, the topology 110 may include the PFC of FIG. 2 (referred to as PFC 112) controlled by controller 111 as discussed with reference to FIGS. 3A and 4. A primary side of a transformer 113 may be between the neutral point (node N) of the first and second switches S1 and S2, and a rectification circuit 114 may be provided on the secondary side of the transformer 113.

The rectification circuit 114 is illustrated as a full wave bridge rectifier comprising four diodes D7-D10, though the present disclosure is not limited thereto. In some embodiments, the rectification circuit 114 may include a half wave bridge rectifier. The rectification circuit 114 may be configured to convert the input signal supplied by the transformer 113 into a DC signal. A filter comprising inductor L4 and capacitor C_{O} is also shown.

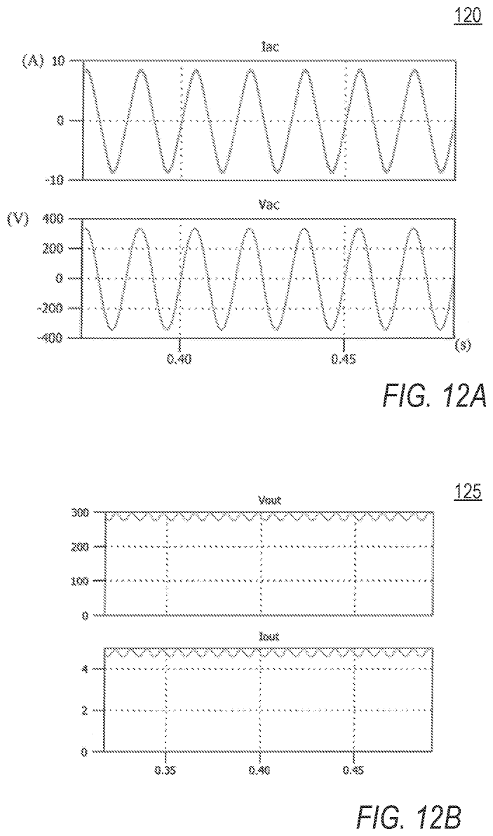

FIGS. 12A and 12B illustrate simulated input 120 and output 125, respectively, of the circuit of FIG. 10. The circuit may operate at 240 V AC input line to line voltage and have an AC input current THD of less than 5%. The output voltage is approximately 300 V DC with less than 5% ripple. The operating power may be up to 1.4 kW.

Many alterations and modifications may be made by those having ordinary skill in the art, given the benefit of present disclosure, without departing from the scope of the inventive concepts. Therefore, it must be understood that the illustrated embodiments have been set forth only for the purposes of example, and that it should not be taken as limiting the inventive concepts as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the inventive concepts.

What is claimed is:

1. A power converter configured to receive an alternating current (AC) input signal and output a direct current (DC) output signal, the power converter comprising a transformer and a power factor correction circuit, the power factor correction circuit comprising:
a first switching transistor comprising a first gate;
a second switching transistor in series with the first switching transistor and comprising a second gate; and
a controller configured to generate first and second pulsed signals having respective and complementary phases and separated by an adjustable deadtime and apply the generated first and second pulsed signals to the first and second gates, respectively,
wherein a primary side of the transformer is coupled to a node between the first and second switching transistors.

2. The power converter of claim 1, further comprising first and second rectifiers on respective sides of the transformer.

3. The power converter of claim 1, wherein the input signal is a single phase input signal.

4. The power converter of claim 1, wherein the input signal is a multi-phase input signal.

5. The power converter of claim 1, wherein the controller is configured to adjust a frequency of pulses of the first and second pulsed signals based on the output voltage of the power factor correction circuit.

6. The power converter of claim 1, wherein the first and second switching transistors are silicon carbide (SiC) metal-oxide-semiconductor field effect transistors (MOSFETs).

7. A power converter configured to receive an alternating current (AC) power signal as an input, the power converter comprising a power factor correction circuit comprising:
at least one rectifier;
a first switching transistor comprising a first gate;
a second switching transistor in series with the first switching transistor and comprising a second gate; and
a controller configured to generate frequency-adjustable first and second pulsed signals having respective and complementary phases separated by an adjustable deadtime,
wherein the controller is configured to adjust a frequency of the first and second pulsed signals and the deadtime separating the first and second pulsed signals based on an output voltage of the at least one rectifier.

8. The power converter of claim 7, wherein the power converter is configured to receive a single-phase AC power signal as an input.

9. The power converter of claim 7, wherein the power converter is configured to receive a multi-phase AC power signal as an input.

10. The power converter of claim 7, wherein the at least one rectifier comprises a full bridge rectifier.

11. The power converter of claim 7, further comprising a transformer having a primary side coupled to a node between the first and second switching transistors.

12. The power converter of claim 7, wherein the at least one rectifier comprises first and second rectifiers on respective sides of the transformer.

13. The power converter of claim 7, further comprising a DC/DC converter.

14. The power converter of claim 7, wherein the DC/DC converter comprises two inductors and a capacitor.

15. The power converter of claim 7, wherein the power factor correction circuit is a first power factor correction circuit, further comprising a second power factor correction circuit coupled in parallel to an input of the power converter.

16. The power converter of claim 7, wherein the first and second switching transistors are silicon carbide (SiC) metal-oxide-semiconductor field effect transistors (MOSFETs).

17. A power converter comprising:
a transformer;
first and second rectifiers on respective first and second sides of the transformer; and
a power factor correction (PFC) circuit, the power factor correction circuit comprising a PFC controller configured to generate frequency-adjustable first and second pulsed signals having respective and complementary phases separated by an adjustable deadtime, the PFC controller comprising a comparator, a frequency controller, and a deadtime controller, the PFC controller configured to:
receive an input signal comprising a measured output voltage of the power factor correction circuit;
compare, via the comparator, the measured output voltage with a set point, resulting in a difference between the measured output voltage and the set point;
feed the difference into the frequency controller and adjust a frequency of the first and second pulsed signals based on an output of the frequency controller; and
provide the difference to the deadtime controller and adjust the deadtime of the first and second pulsed signals based on an output of the deadtime controller.

18. The power converter of claim 17, wherein the first and second pulsed signals respectively drive gates of first and second switching transistors located on the first side of the transformer.

19. The power converter of claim 17, wherein the frequency controller comprises a compensator or a voltage controlled oscillator.

20. The power converter of claim 17, wherein the controller comprises a pulse-width modulation (PWM) signal generator configured to receive the output of the frequency controller and the output of the deadtime controller.
